(19) United States
(12) Patent Application Publication
(10) Pub. No.: US 2014/0297257 A1
(43) Pub. Date: Oct. 2, 2014

(54) MOTION SENSOR-BASED PORTABLE AUTOMATIC INTERPRETATION APPARATUS AND CONTROL METHOD THEREOF

(71) Applicant: ELECTRONICS AND TELECOMMUNICATIONS RESEARCH INSTITUTE, Daejeon-city (KR)

(72) Inventors: Jong-Hun SHIN, Daejeon (KR); Young-Kil KIM, Daejeon (KR); Chang-Hyun KIM, Daejeon (KR); Young-Ae SEO, Daejeon (KR); Seong-Il YANG, Daejeon (KR); Jin-Xia HUANG, Daejeon (KR); Seung-Hoon NA, Daejeon (KR); Oh-Woog KWON, Daejeon (KR); Ki-Young LEE, Daejeon (KR); Yoon-Hyung ROH, Daejeon (KR); Sung-Kwon CHOI, Daejeon (KR); Sang-Keun JUNG, Daejeon (KR); Yun JIN, Daejeon (KR); Eun-Jin PARK, Daejeon (KR); Sang-Kyu PARK, Daejeon (KR)

(73) Assignee: ELECTRONICS AND TELECOMMUNICATIONS RESEARCH INSTITUTE, Daejeon-city (KR)

(21) Appl. No.: 14/065,579

(22) Filed: Oct. 29, 2013

(30) Foreign Application Priority Data
Mar. 26, 2013 (KR) 10-2013-0032339

(51) Int. Cl. G06F 17/28

(52) U.S. Cl. CPC G06F 17/28
USPC 704/3

(57) ABSTRACT

Disclosed herein is a motion sensor-based portable automatic interpretation apparatus and control method thereof, which can precisely detect the start time and the end time of utterance of a user in a portable automatic interpretation system, thus improving the quality of the automatic interpretation system. The motion sensor-based portable automatic interpretation apparatus includes a motion sensing unit for sensing a motion of the portable automatic interpretation apparatus. An utterance start time detection unit detects an utterance start time based on an output signal of the motion sensing unit. An utterance end time detection unit detects an utterance end time based on an output signal of the motion sensing unit after the utterance start time has been detected.

### CROSS REFERENCE TO RELATED APPLICATION

This application claims the benefit of Korean Patent Application No. 10-2013-0032339 filed on Mar. 26, 2013, which is hereby incorporated by reference in its entirety into this application.

### BACKGROUND OF THE INVENTION

1. Technical Field

The present invention relates generally to a motion sensor-based portable automatic interpretation apparatus and control method thereof and, more particularly, to a motion sensor-based portable automatic interpretation apparatus and control method thereof, which can provide assistance to automatic interpretation by tracking the operation of a user using a motion sensor.

2. Description of the Related Art

An automatic interpretation system in a conventional portable device is mainly configured to perform interaction by utilizing both the touch action of a user touching his or her finger on a screen and the action of speaking into a microphone and transferring speech data.

In accordance with conventional technology utilized in touch-based portable devices, automatic interpretation is typically performed through the following process. First, a user basically conducts language selection by determining a language to be interpreted (a source language) and a resulting language to be obtained (a target language) via interpretation. Second, the user touches a “speech input” button on the screen so as to execute speech recognition before speaking (utterance). Third, an automatic interpretation system notifies the user that speech is being recorded in the form of a sound or a variation on the screen and receives speech from the user. Fourth, when the user stops speaking and a sound level above a predetermined decibel is not maintained, a procedure is performed in which a speech recognition module recognizes that speaking is terminated and converts speech data into text. Alternatively, a procedure is performed in which the user personally touches a button such as a “recognition completion” button on the screen to explicitly notify the system of the termination of the user's speaking and in which the speech recognition module converts speech data into text. Fifth, if the speech recognition module has completed its execution, the results of the execution are displayed on the screen, and results in a target language are obtained using an automatic translation module. Sixth, target language text obtained by the automatic translation module is combined with speech via a Text-to-Speech (TTS) module, and resulting speech is provided back to the user. Seventh, the user returns to a state in which a button required to change a language pair (for example, “English ->Korean” is exchanged for “Korean ->English” or vice versa) or required to resume speech recognition is pressed.

In this case, depending on how precisely the start point and end point of speech speaking (utterance) can be detected, the quality of speech recognition results may greatly differ. In particular, there occur cases where existing End Point Detection (EPD) for automatically recognizing the end point of speech utterance makes it difficult to detect the accurate boundary of speech utterance. For example, in some cases, when the user temporarily stops speaking or hesitates to speak, as in the case of sound “er” or “Hmmm,” an additional input signal is not received through a microphone, and thus it may be recognized that speech utterance has been terminated.

Therefore, in the conventional technology, a button indicating the start/end of utterance is generated on the screen, and allows the user to take the action of personally touching the screen and explicitly notifying the corresponding device of the start point and the end point of utterance. In this way, when screen touch is utilized, a button may be falsely pressed or touch recognition may be erroneously performed, so that the start/end of utterance is falsely determined, and the results of speech recognition are deteriorated, thus exhibiting bad interpretation quality.

Meanwhile, Korean Patent No. 10-0981200 (entitled “Mobile terminal equipped with a motion sensor and method of controlling the same”) discloses technology for controlling a mobile terminal using a motion sensor. The method of controlling a user interface disclosed in Korean Patent No. 10-0981200 relates to a method of controlling the user interface of a mobile terminal having a plurality of different operation modes and at least one function designated for each operation mode. This method includes the step of detecting the motion of the mobile terminal applied by a user's gesture; determining the current operation mode of the mobile terminal among a plurality of operation modes; and executing at least one function designated for the determined current operation mode depending on the detected motion of the mobile terminal.

The technology disclosed in the above Korean Patent No. 10-0981200 employs a motion sensor, but is focused only on the manipulation of a typical smart terminal or an MP3 player.

### SUMMARY OF THE INVENTION

Accordingly, the present invention has been made keeping in mind the above problems occurring in the prior art, and an object of the present invention is to provide a motion sensor-based portable automatic interpretation apparatus and control method thereof, which can precisely detect the start time and the end time of utterance of a user in a portable automatic interpretation system, thus improving the quality of the automatic interpretation system.

Another object of the present invention is to improve the quality of an automatic interpretation system by definitely detecting a language pair change command from a user in the automatic interpretation system and to provide an interface that allows the user to more easily utilize an interpretation system operated by a portable device equipped with a motion sensor, such as a smart phone, in the interpretation system.

In accordance with an aspect of the present invention to accomplish the above objects, there is provided a motion sensor-based portable automatic interpretation apparatus, including a motion sensing unit for sensing a motion of the portable automatic interpretation apparatus and outputting sensor result values of X, Y, and Z axes; an utterance start time detection unit for detecting an utterance start time based on an output signal of the motion sensing unit; and an utterance end time detection unit for detecting an utterance end time based on an output signal of the motion sensing unit after the utterance start time has been detected.

Preferably, the utterance start time detection unit may detect time, at which an output signal of the motion sensing unit corresponding to motion in which the portable automatic interpretation apparatus enters a horizontal state with respect to a Y axis is input, as the utterance start time.

Preferably, the utterance end time detection unit may detect time, at which an output signal of the motion sensing unit corresponding to motion in which the portable automatic interpretation apparatus moves from a horizontal state to a vertical direction with respect to a Y axis is input after the utterance start time has been detected, as the utterance end time.

Preferably, the motion sensor-based portable automatic interpretation apparatus may further include a language pair change detection unit for, when inversion between sensor result values of an X axis and a Y axis occurs in the output signal of the motion sensing unit, recognizing the output signal as a language pair change command. In this case, the language pair change detection unit may perform an operation of recognizing the language pair change command after automatic interpretation between a source language and a target language has been performed at least once.

Preferably, the motion sensing unit may include one or more of an acceleration sensor and a gyro sensor.

Preferably, the X axis may correspond to a width direction of the portable automatic interpretation apparatus, the Y axis may correspond to a longitudinal direction of the portable automatic interpretation apparatus, and the Z axis may correspond to a height direction of the portable automatic interpretation apparatus.

In accordance with another aspect of the present invention to accomplish the above objects, there is provided a method of controlling motion sensor-based automatic interpretation, including sensing, by a motion sensing unit, motion of a portable automatic interpretation apparatus and outputting sensor result values of X, Y, and Z axes; detecting, by an utterance start time detection unit, an utterance start time based on an output signal obtained at outputting the sensor result values of the X, Y, and Z axes; and detecting, by an utterance end time detection unit, an utterance end time based on an output signal obtained at outputting the sensor result values of the X, Y, and Z axes after the utterance start time has been detected.

Preferably, detecting the utterance start time may be configured to detect time, at which the portable automatic interpretation apparatus enters a horizontal state with respect to a Y axis, as the utterance start time.

Preferably, detecting the utterance end time may be configured to detect time, at which the portable automatic interpretation apparatus moves from a horizontal state to a vertical direction with respect to a Y axis after the utterance start time has been detected, as the utterance end time.

Preferably, the method may further include, when inversion between sensor result values of an X axis and a Y axis occurs in the output signal obtained at outputting the sensor result values of the X, Y, and Z axes, recognizing, by a language pair change detection unit, the output signal as a language pair change command. In this case, recognizing as the language pair change command may be performed after automatic interpretation between a source language and a target language has been performed at least once.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a motion sensor-based portable automatic interpretation apparatus according to an embodiment of the present invention;

FIGS. 2 and 3 are diagrams showing the references of X, Y, and Z axes according to an embodiment of the present invention;

FIG. 4 is a flowchart showing a method of controlling motion sensor-based automatic interpretation according to an embodiment of the present invention;

FIGS. 5 and 6 are diagrams showing the initial status of a portable automatic interpretation apparatus;

FIG. 7 is a diagram showing the final status of the portable automatic interpretation apparatus in which an utterance start time is detected;

FIG. 8 is a diagram showing the movement status of the portable automatic interpretation apparatus in which an utterance end time is detected; and

FIG. 9 is a flowchart showing a process for detecting a language pair change command according to an embodiment of the present invention.

### DESCRIPTION OF THE PREFERRED EMBODIMENTS

The present invention is intended to detect a behavioral pattern frequently expressed by a user, who utilizes an automatic interpretation system in a portable device, in the form of motion, and to allow the automatic interpretation system to automatically detect the start time and end time of speech based on such motion when the user normally speaks and when the user talks with a person who uses another language.

Hereinafter, a motion sensor-based portable automatic interpretation apparatus and control method thereof according to embodiments of the present invention will be described in detail with reference to the accompanying drawings. Prior to the detailed description of the present invention, it should be noted that the terms or words used in the present specification and the accompanying claims should not be limitedly interpreted as having their common meanings or those found in dictionaries. Therefore, the embodiments described in the present specification and constructions shown in the drawings are only the most preferable embodiments of the present invention, and are not representative of the entire technical spirit of the present invention. Accordingly, it should be understood that various equivalents and modifications capable of replacing the embodiments and constructions of the present invention might be present at the time at which the present invention was filed.

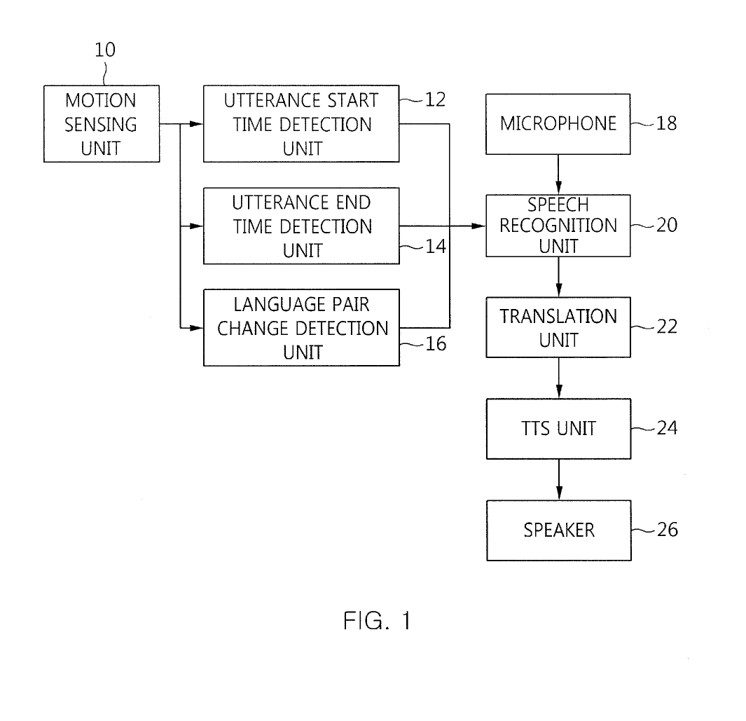

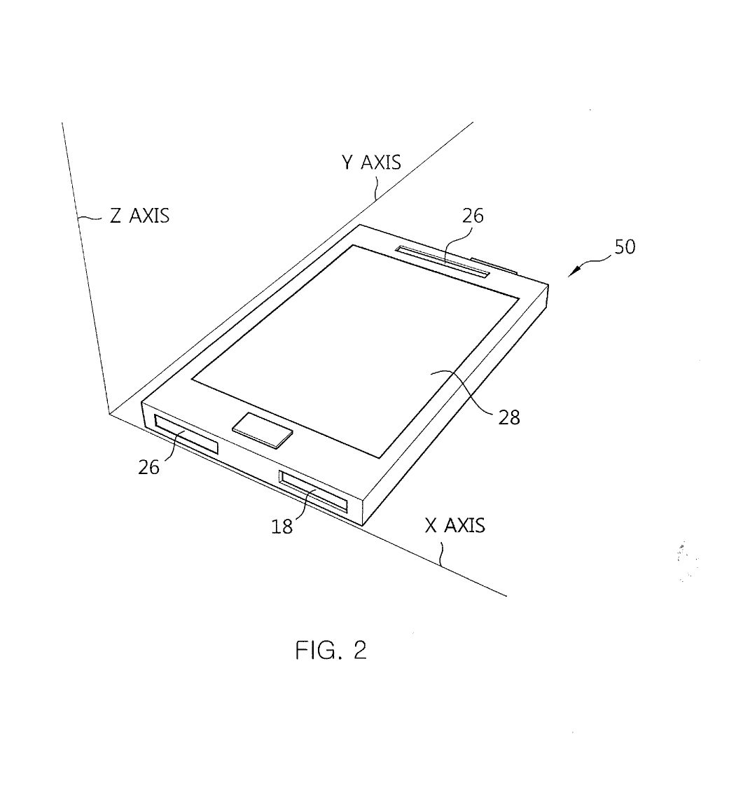

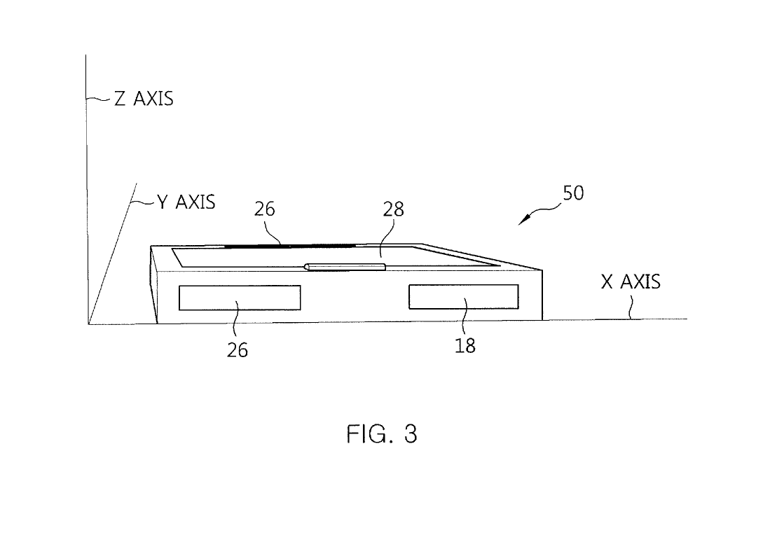

FIG. 1 is a block diagram showing a motion sensor-based portable automatic interpretation apparatus according to an embodiment of the present invention, and FIGS. 2 and 3 are diagrams showing the references of X, Y, and Z axes used in the embodiment of the present invention.

A motion sensor-based portable automatic interpretation apparatus according to an embodiment of the present invention includes a motion sensing unit 10, an utterance start time detection unit 12, an utterance end time detection unit 14, a language pair change detection unit 16, a microphone 18, a speech recognition unit 20, a translation unit 22, a Text to Speech (TTS) unit 24, and a speaker 26.

The motion sensing unit 10 senses the motion of the portable automatic interpretation apparatus and outputs sensor result values of the X, Y and Z axes (for example, gravity acceleration values) occurring as the user holds and moves the portable automatic interpretation apparatus. Preferably the motion sensing unit 10 includes one or more of an acceleration sensor and a gyro sensor (gyroscope). For example, a 3-axis acceleration sensor may be used, and a 2-axis acceleration sensor and a 1-axis gyro sensor may be used together. Of course, in addition to the acceleration sensor and the gyro sensor, any type of sensor may be employed in the present invention as long as it is capable of sensing the motion of the portable automatic interpretation apparatus. Which motion was conducted by the portable automatic interpretation apparatus can be detected based on the sensor result values of the X, Y, and Z axes output from these sensors.

Meanwhile, the portable automatic interpretation apparatus may be a smart phone, such as an Android phone or an iPhone. Such a smart phone contains therein an automatic interpretation system. Consequently, the smart phone containing the automatic interpretation system may be referred to as the portable automatic interpretation apparatus, or the automatic interpretation system in the smart phone may also be referred to as the portable automatic interpretation apparatus.

The references of the X, Y, and Z axes in the embodiment of the present invention will be described below. In FIGS. 2 and 3, when a portable automatic interpretation apparatus 50 is viewed in a front direction (that is, viewed from a surface on which a touch screen 28 is present), a lateral direction corresponds to an X axis and a vertical direction corresponds to a Y axis. When the portable automatic interpretation apparatus 50 is viewed from a side surface, an axis in a direction extending from the rear surface of the portable automatic interpretation apparatus 50 to the front surface thereof corresponds to a Z axis. In other words, it may be considered that the X axis corresponds to the width direction of the portable automatic interpretation apparatus 50, the Y axis corresponds to the longitudinal direction of the portable automatic interpretation apparatus 50, and the Z axis corresponds to the height direction of the portable automatic interpretation apparatus 50.

In FIG. 1, the utterance start time detection unit 12 detects an utterance start time based on the output signal of the motion sensing unit 10. If the utterance start time is detected by the utterance start time detection unit 12, the speech recognition unit 20 receives microphone input for speech recognition. The utterance start time detection unit 12 detects time at which the output signal of the motion sensing unit 10, corresponding to motion in which the portable automatic interpretation apparatus enters a horizontal state with respect to the Y axis, is input, as an utterance start time. In greater detail, the utterance start time detection unit 12 is configured to, when the output signal of the motion sensing unit 10 is a signal corresponding to time at which the Y axis of the portable automatic interpretation apparatus has moved in a horizontal direction and the Z axis has moved in a vertical direction and thereafter the movement deviation of the portable automatic interpretation apparatus rapidly decreases, receive the signal as a command indicating the start of an utterance.

The utterance start time detection unit 12 may previously store a table in which the sensor result values of the X, Y, and Z axes are combined and different contents for the combined sensor result values of respective X, Y, and Z axes are recorded. Accordingly, the utterance start time detection unit 12 may decode the meaning of the output signal of the motion sensing unit 10 based on the information stored in the table and detect the utterance start time.

The utterance end time detection unit 14 detects an utterance end time based on the output signal of the motion sensing unit 10 in a state in which the detection of the utterance start time is performed by the utterance start time detection unit 12 and the speech of the user is being transferred to the speech recognition unit 20 via the microphone 18. Preferably, in the state in which the utterance start time has been detected by the utterance start time detection unit 12 and the speech of the user is transferred to the speech recognition unit 20 through the microphone 18, the utterance end time detection unit 14 detects time, at which the output signal of the motion sensing unit 10, corresponding to time at which the portable automatic interpretation apparatus moves from the horizontal state to a vertical direction with respect to the Y axis and thereafter has less motion deviation, is input, as an utterance end time.

The utterance end time detection unit 14 may previously store a table in which the sensor result values of the X, Y, and Z axes are combined and different contents for the combined sensor result values of respective X, Y, and Z axes are recorded. Accordingly, the utterance end time detection unit 14 may decode the meaning of the output signal of the motion sensing unit 10 based on the information stored in the table and detect the utterance end time.

The language pair change detection unit 16 is configured to, when there is an output signal corresponding to time at which inversion between the sensor result value of the X axis and the sensor result value of the Y axis has greatly occurred in the output signal of the motion sensing unit 10 and then the motion deviation of the portable automatic interpretation apparatus is decreased, recognize the corresponding output signal as a language pair change command. In this way, if the language pair change detection unit 16 recognizes the language pair change command and sends a signal corresponding to the command to the speech recognition unit 20, the speech recognition unit 20 exchanges a source language and a target language for each other, and performs speech recognition. The change of a pair of a source language and a target language will be described by way of example. When a first user sets Korean as a source language and English as a target language, the first user utters Korean and transfers Korean speech to the portable automatic interpretation apparatus, and the portable automatic interpretation apparatus outputs the target language, that is, English speech, through the speaker 26. In the case where the native language of a second user is English and the target language thereof is Korean, if a language pair change command is recognized, the portable automatic interpretation apparatus changes the source language to English and the target language to Korean. Accordingly, when the second user speaks in English and speech data is transferred to the portable automatic interpretation apparatus, the portable automatic interpretation apparatus outputs the corresponding speech data in Korean.

The language pair change detection unit 16 may previously store a table in which the sensor result values of the X, Y, and Z axes are combined and different contents for the combined sensor result values of respective X, Y, and Z axes are recorded. Accordingly, the language pair change detection unit 16 may decode the meaning of the output signal of the motion sensing unit 10 based on the information stored in the table, and detect (recognize) the language pair change command.

The microphone 18 is installed in the portable automatic interpretation apparatus and collects speech utterances made by the user.

The speech recognition unit 20 converts speech data input through the microphone 18 into text based on the utterance start time detection signal output from the utterance start time detection unit 12 and the utterance end time detection signal output from the utterance end time detection unit 14. That is, when utterance is initiated, the speech recognition unit 20 receives the speech utterance of the user through the microphone 18 and stores the speech utterance. Then, when the utterance is terminated, the speech recognition unit 20 converts stored speech data into text. The speech recognition unit 20 may be regarded as performing speech recognition via a speech recognition program. It may be considered that details of speech recognition can be sufficiently understood by those skilled in the art based on well-known technology.

The translation unit 22 outputs results obtained by translating text (that is, text in a source language) output from the speech recognition unit 20 into a target language (that is, text). It may be considered that details of the translation process of the translation unit 22 can be sufficiently understood by those skilled in the art based on well-known technology.

The Text-to-Speech (TTS) unit 24 converts the text output from the translation unit 22 into speech and outputs the speech to the outside of the interpretation apparatus through the speaker 26.

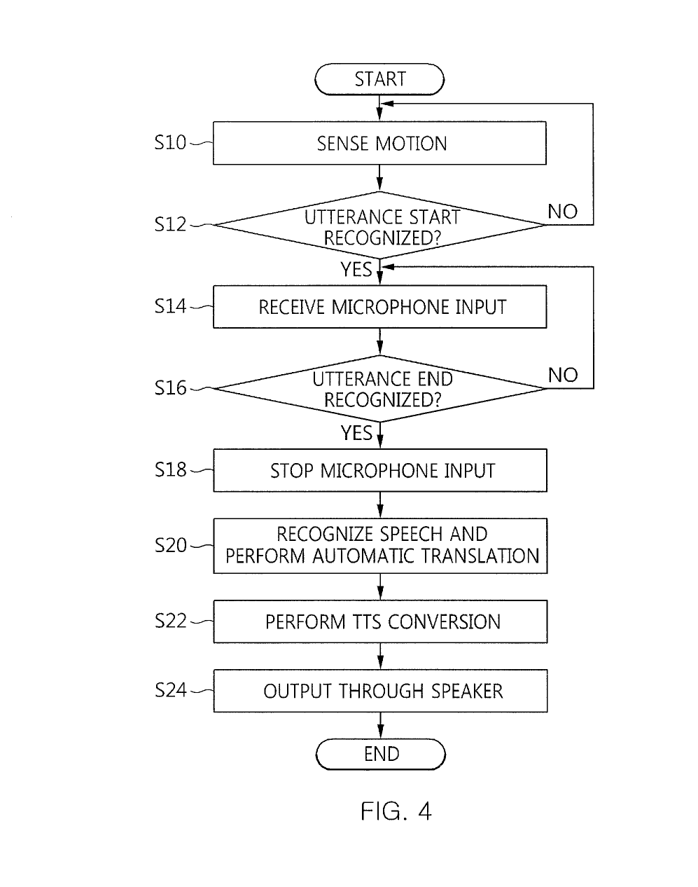

Hereinafter, a method of controlling motion sensor-based automatic interpretation according to an embodiment of the present invention will be described in detail with reference to the flowchart of FIG. 4.

At step S10, the motion sensing unit 10 senses the motion of the portable automatic interpretation apparatus.

At step S12, the utterance start time detection unit 12 detects an utterance start time based on the sensor result values of the X, Y, and Z axes output from the motion sensing unit 10.

In the past, since the utterance start time cannot be automatically detected, a command for indicating the start of utterance is transferred to the portable automatic interpretation apparatus by touching a specitic button on the screen of the apparatus, but the present invention focuses on the action of moving the microphone 18 close to the face of a user, in particular, the mouth of the user, so as to transfer accurate speech to the apparatus.

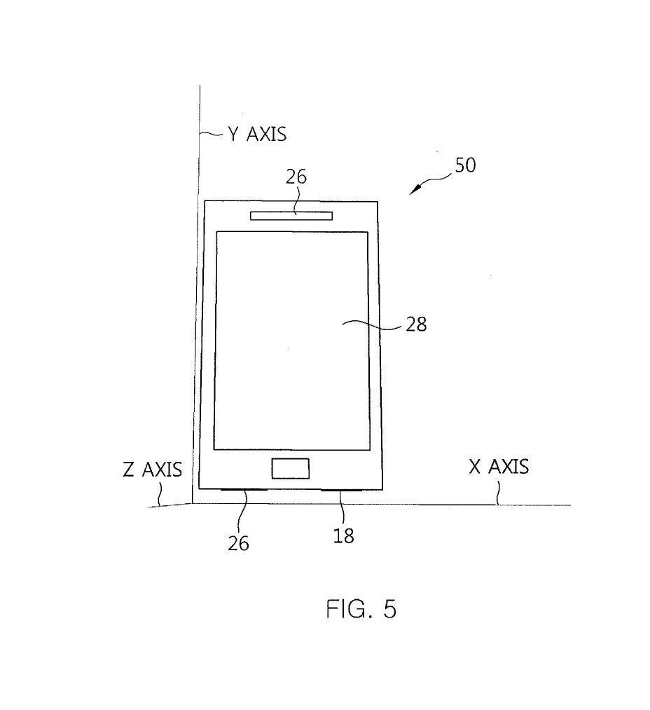

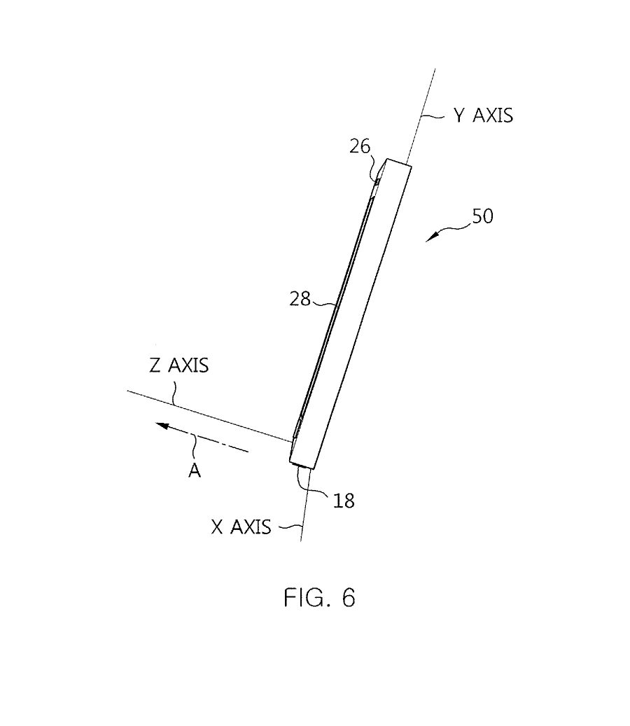

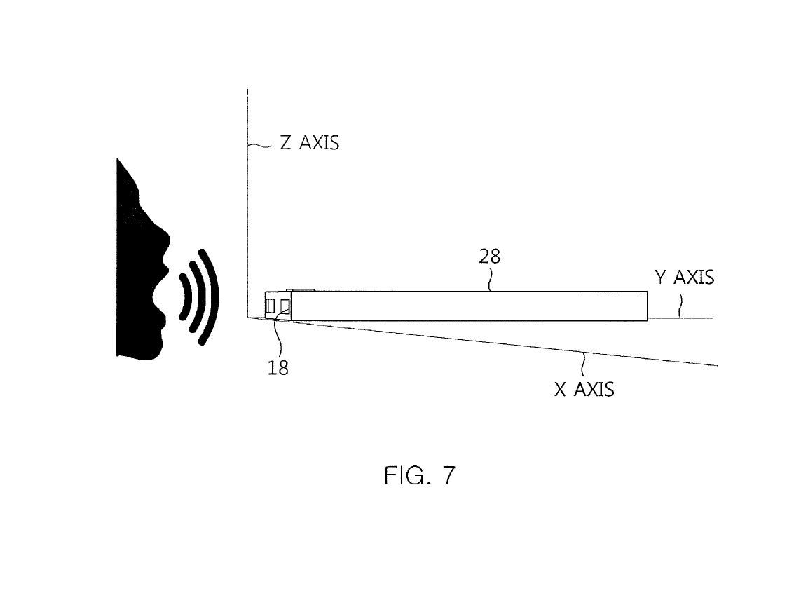

When a value indicated by the motion sensing unit 10 represents time at which motion in which the front of the apparatus (that is, the surface on which a touch screen is present) faces a ground surface, or the reverse motion thereof is detected, the utterance start time detection unit 12 of the present invention recognizes the time as an utterance start time. FIGS. 5 and 6 illustrate the initial status of the portable automatic interpretation apparatus 50, that is, the incline and movement status of the portable automatic interpretation apparatus 50 which waits for an utterance start command. This status may be a state in which the user holds the rear surface of the portable automatic interpretation apparatus 50 with his or her hand, or a state in which the portable automatic interpretation apparatus 50 is supported by a specific object. In such initial status, in order for the user to initiate utterance, the user leans and moves the portable automatic interpretation apparatus 50 in the direction of arrow A to move a portion of the microphone 18 close to the face (in detail, mouth) of the user. If the microphone 18 is moved close to the mouth of the user in this way, the status illustrated in FIG. 7 is obtained. That is, depending on the location of the microphone 18, the front surface (the surface on which the touch screen 28 is present) and the rear surface may be reversed. However, the utterance start time detection unit 12 receives motion, which makes the portable automatic interpretation apparatus 50 be in a state close to a vertical direction with respect to the Z axis and a horizontal direction with respect to the Y axis, as a command for indicating the start of utterance. In other words, the utterance start time detection unit 12 is configured to, if time at which the Z axis of the portable automatic interpretation apparatus 50 has moved in the vertical direction and the Y axis thereof has moved in the horizontal direction and thereafter the movement deviation of the portable automatic interpretation apparatus 50 has rapidly decreased is detected, detect this time as the utterance start time.

In this way, if the utterance start time is detected by the utterance start time detection unit 12, the utterance start time detection unit 12 transmits a signal corresponding to the utterance start time to the speech recognition unit 20.

At step S14, the speech recognition unit 20 receives speech data input through the microphone 18 and temporarily stores the speech data.

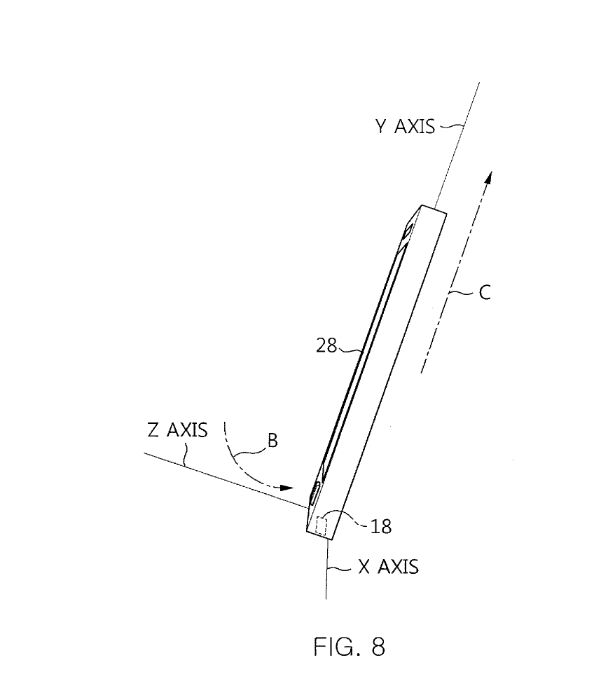

At step S16, the utterance end time detection unit 14 detects an utterance end time. In a state in which the utterance start time is detected and the speech of the user is transferred to and stored in the speech recognition unit 20 through the microphone 18, if the sensor result value of the Y axis of the motion sensing unit 10 is detected as time at which the portable automatic interpretation apparatus 50 has moved in the vertical direction and thereafter has less motion deviation, the utterance end time detection unit 14 recognizes this time as an utterance end time. The final location of the moved portable automatic interpretation apparatus represents a shape similar to that shown in FIG. 8. That is, in the state of FIG. 7, a portion in which the microphone 18 is present is moved in the direction of arrow B, and a portion opposite to that of the microphone 18 is moved in the direction of arrow C.

In this way, if the utterance end time has been detected by the utterance end time detection unit 14, the utterance end time detection unit 14 sends a signal corresponding to the utterance end time to the speech recognition unit 20.

At step S18, the speech recognition unit 20 stops the input of the microphone. As occasion demands, the procedure of step S18 may be omitted.

At step S20, the speech recognition unit 20 converts the speech data stored during a period from the utterance start time to the utterance end time into text, and the translation unit 22 translates the converted text into text in a target language.

At step S22, the TTS unit 24 converts the text in the target language output from the translation unit 22 into speech.

At step S24, the TTS unit 24 outputs the converted results (speech in the target language) to the outside through the speaker 26.

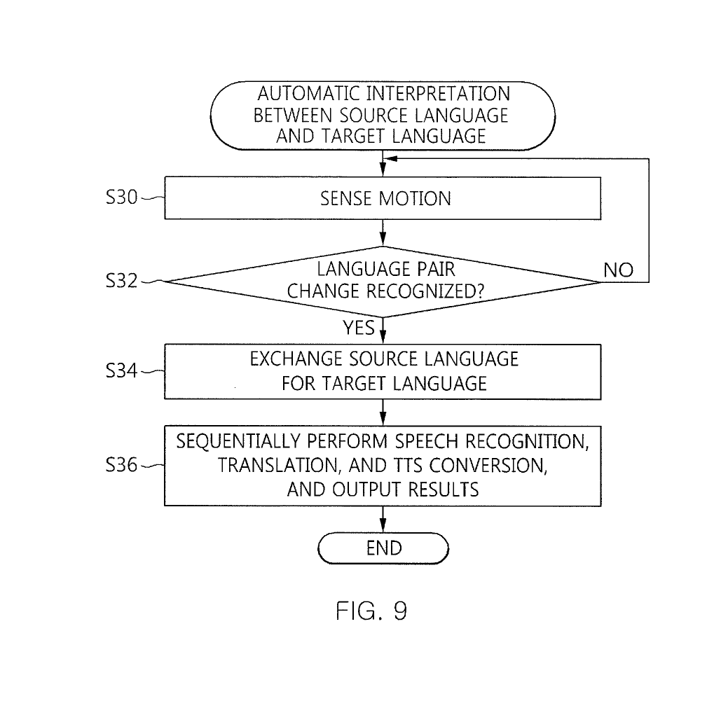

Next, a process for detecting a language pair change command in the embodiment of the present invention will be described in detail with reference to the flowchart of FIG. 9.

In order for the language pair change detection unit 16 to detect a language pair change command, a precondition is required. That is, automatic interpretation between a source language and a target language should have been performed at least once in advance. Otherwise, the language pair change detection unit 16 sensitively reacts to the motion of the portable automatic interpretation apparatus and changes a pair of languages unintended by the user.

At step S30, as described above, after automatic interpretation between the source language and the target language has been performed at least once, the motion sensing unit 10 continues to sense the motion of the portable automatic interpretation apparatus.

At step S32, the language pair change detection unit 16 detects a language pair change command based on the output signal of the motion sensing unit 10. Here, the movement of the portable automatic interpretation apparatus required to detect a language pair change command must satisfy the following condition. First, the movement of the portable automatic interpretation apparatus must be present in the direction of the Y axis. A situation in which the portable automatic interpretation apparatus (for example, a smart phone) is passed to the other party is taken into consideration, and the other party takes the portable automatic interpretation apparatus and accurately grips the apparatus. In order for the other party to accurately grip the portable automatic interpretation apparatus, inversion between the values of the X axis and the Y axis of the portable automatic interpretation apparatus greatly occurs. The language pair change detection unit 16 recognizes a signal corresponding to time, at which the portable automatic interpretation apparatus becomes far away from an original device user and the movement of the X and Y axes greatly occurs again and thereafter the movement deviation of the portable automatic interpretation apparatus is decreased, as a language pair change command.

If the language pair change command has been recognized, the language pair change detection unit 16 sends a signal corresponding to the command to the speech recognition unit 20.

At step S34, the speech recognition unit 20 exchanges the source language and the target language, which have been previously set, for each other.

At step S36, the procedures, such as speech recognition, translation, and TTS conversion shown in FIG. 4, are sequentially performed, and thus speech in the target language is output through the speaker 26.

In accordance with the present invention having the above configuration, the portable automatic interpretation apparatus automatically detects speech recognition start time and end time for interpretation, based on the motion of a user's device, thus improving the convenience of the user.

Further, the present invention can more definitely detect the recognition start/end times of the portable automatic interpretation apparatus, thus enhancing the interpretation quality of the portable interpretation apparatus.

Furthermore, the present invention is advantageous in that, in the case of interpretation between two or more users, the change of a language pair can be conducted using only the action of passing the portable automatic interpretation apparatus, so that a source language to be interpreted can be exactly known and the number of manipulations on a screen can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A motion sensor-based portable automatic interpretation apparatus, comprising:
a motion sensing unit for sensing a motion of the portable automatic interpretation apparatus;
an utterance start time detection unit for detecting an utterance start time based on an output signal of the motion sensing unit; and
an utterance end time detection unit for detecting an utterance end time based on an output signal of the motion sensing unit after the utterance start time has been detected.

2. The motion sensor-based portable automatic interpretation apparatus of claim 1, wherein the utterance start time detection unit detects time, at which an output signal of the motion sensing unit corresponding to motion in which the portable automatic interpretation apparatus enters a horizontal state with respect to a Y axis is input, as the utterance start time.

3. The motion sensor-based portable automatic interpretation apparatus of claim 1, wherein the utterance end time detection unit detects time, at which an output signal of the motion sensing unit corresponding to motion in which the portable automatic interpretation apparatus moves from a horizontal state to a vertical direction with respect to a Y axis is input after the utterance start time has been detected, as the utterance end time.

4. The motion sensor-based portable automatic interpretation apparatus of claim 1, further comprising a language pair change detection unit for, when inversion between sensor result values of an X axis and a Y axis occurs in the output signal of the motion sensing unit, recognizing the output signal as a language pair change command.

5. The motion sensor-based portable automatic interpretation apparatus of claim 4, wherein the language pair change detection unit performs an operation of recognizing the language pair change command after automatic interpretation between a source language and a target language has been performed at least once.

6. The motion sensor-based portable automatic interpretation apparatus of claim 1, wherein the motion sensing unit comprises one or more of an acceleration sensor and a gyro sensor.

7. The motion sensor-based portable automatic interpretation apparatus of claim 1, wherein the motion sensing unit outputs sensor result values, obtained by sensing the motion of the portable automatic interpretation apparatus in directions of X, Y, and Z axes, as the output signal.

8. A method of controlling motion sensor-based automatic interpretation, comprising:
sensing, by a motion sensing unit, motion of a portable automatic interpretation apparatus;
detecting, by an utterance start time detection unit, an utterance start time based on an output signal obtained at sensing the motion of the portable automatic interpretation apparatus; and
detecting, by an utterance end time detection unit, an utterance end time based on an output signal obtained at sensing the motion of the portable automatic interpretation apparatus after the utterance start time has been detected.

9. The method of claim 8, wherein detecting the utterance start time is configured to detect time, at which the portable automatic interpretation apparatus enters a horizontal state with respect to a Y axis, as the utterance start time.

10. The method of claim 8, wherein detecting the utterance end time is configured to detect time, at which the portable automatic interpretation apparatus moves from a horizontal state to a vertical direction with respect to a Y axis after the utterance start time has been detected, as the utterance end time.

11. The method of claim 8, further comprising:
when inversion between sensor result values of an X axis and a Y axis occurs in the output signal obtained at sensing of the motion of the portable automatic interpretation apparatus, recognizing, by a language pair change detection unit, the output signal as a language pair change command.

12. The method of claim 11, wherein recognizing as the language pair change command is performed after automatic interpretation between a source language and a target language has been performed at least once.

13. The method of claim 8, wherein detecting the motion of the portable automatic interpretation apparatus is configured to output sensor result values, obtained by sensing the motion of the portable automatic interpretation apparatus in directions of X, Y, and Z axes, as the output signal.
